(19) United States
(12) Patent Application Publication
(10) Pub. No.: US 2013/0037585 A1
(43) Pub. Date: Feb. 14, 2013

(54) CONNECTION ASSEMBLY

(71) Applicants: Peter Douglas Hubbard, Christchurch (NZ); Bruce John Robertson, Christchurch (NZ)

(72) Inventors: Peter Douglas Hubbard, Christchurch (NZ); Bruce John Robertson, Christchurch (NZ)

(73) Assignee: HUBCO AUTOMOTIVE LIMITED, Wellington (NZ)

(21) Appl. No.: 13/512,267

(22) PCT Filed: Nov. 29, 2010
(86) PCT No.: PCT/NZ2010/000237

§ 371 Date: Nov. 2, 2012

(30) Foreign Application Priority Data
Dec. 1, 2009 (NZ) 581567

(51) Int. Cl. B60R 9/048

(52) U.S. Cl. 224/324

(57) ABSTRACT

A connection assembly is described that may be used to snap fit and lock together a channel containing member to other members. One embodiment described is use of the connection assembly to snap fit and lock together a roof rack accessory rack or item to fit roof rack crossbar on a vehicle.

### TECHNICAL FIELD

The invention relates to a connection assembly. More specifically, the invention relates to an assembly and related method to link or connect a vehicle roof rack to another item such as an accessory rack or accessory item.

### BACKGROUND ART

Vehicle roof racks are well known in the art with many products existing relating to a variety of different parts of various roof rack systems and the loads carried by such racks.

A typical design of vehicle roof rack involves fitting of two cross bars across the roof of the vehicle at the front and rear of the vehicle roof. Various items may then be placed onto the cross bars for example, cycle holders, trade rack holders, kayak holders, fishing rod holders, surfboard holders and many other accessory racks or accessory items. The various accessory items may be directly attached to the crossbars or further forward facing racks used on which the accessory item(s) are mounted.

Connecting the crossbars to the accessory item or accessory racks is an important feature in roof rack assemblies as the link needs to provide significant strength to retain the carried item on the rack when the vehicle is driven.

A variety of designs exist for this connection however, the designs are typically very simple in design, mainly in response to strength design requirements. For example, the connection is typically a bolt or similar connection means. Whilst this design may meet the strength requirement, it is not always simple to install, particularly when the vehicle roof may be elevated and difficult to reach. Bolt designs also tend to require tools to be used e.g. a screw driver or wrench in order to tighten the bolt(s). Further, attachment takes time to achieve due to the use of additional items e.g. tools and hard to access fixtures. Still further, small parts such as bolts may be lost or dropped during fitting. Also, as often the linking means are exposed on the vehicle roof, they may be weakened by environmental factors such as corrosion, they may provide wind resistance and therefore be noisy and reduce fuel efficiency. Finally, they may reduce the aesthetics of the vehicle.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description that is given by way of example only.

### DISCLOSURE OF THE INVENTION

The invention broadly relates to a connection assembly designed to connect or link an extrusion such as a vehicle roof rack to a rack accessory or directly to an accessory item. As may be appreciated, such a connection assembly must be strong in order to withstand the forces experienced on the roof of a vehicle in motion and, given the sometimes awkward position of racks of vehicles roofs, the connection assembly should be simple to use and attach. Ideally, the assembly should also be aerodynamic and aesthetically pleasing.

According to a first aspect of the present invention there is provided a connection assembly to link parts of a vehicle roof rack including at least two opposing jaw members that are shaped to fit and be received by a channel and wherein, the jaw members may be compressed together so as to slot into a channel and, once in the channel, retain the connection assembly within the channel.

In one embodiment, the jaw assembly also includes a biasing means that, when the lever assembly is in an open position, the biasing means forces the jaws into an at least partially open or spread position but, on compression together such as when forced through a channel aperture, the jaws are free to move together and then bias outwards or apart again once in position. In a preferred embodiment, the biasing means may be two springs that are linked between a frame support structure and two boss projections on either side of the jaws of the jaw assembly.

In one embodiment, the jaw assembly includes two opposing articulated members that interpose with each other and which rotate about a common axis at the jaw apex to open and close the articulated members along a lateral plane. Optionally the jaw assembly also allows for movement of the jaws in a vertical plane as well. Rotation preferably occurs about a jaw assembly pivot rod that links the two jaw members together at the approximate apex of the jaw members.

Preferably the articulated jaw members may be shaped with an angled profile adapted to be received into a channel, preferably in a longitudinal alignment. For the purposes of this specification, the term ‘channel’ refers to an aperture in a member to which the connection assembly may be attached to. Examples of channel containing members include an extrusion such as a roof rack bar, a moulding or a die cast. In one embodiment, the channel may be a T-slot channel inside a roof rack bar extrusion, for example a roof rack cross bar on a vehicle. The angled profile may be such that, when the jaw members are forced apart in a lateral plane, the profile bites on the flanges of the T-slot channel and compress the flanges between the jaws and base member of the connection assembly. Alternatively, if the channel does not include T-slot flanges, the jaws may act to bite and impinge on the exterior walls of the channel or other protrusions or indentations in the channel.

The inventors have found that the angle of the articulated jaw members and in particular the angle of the section(s) that strikes the channel is critical in order to achieve the desired snap fit and lock action. If the angle is too steep relative to the jaw assembly pivot axis, the jaws will fit too easily into the channel and may not be sufficiently held. In contrast, if the angle is too shallow relative to the jaw assembly pivot axis, the jaws are difficult if not impossible to fit through the channel. The ideal angle range identified by the inventors is from 30 to 40 degrees relative to a perpendicular axis. Notwithstanding this range of angle, the angles of the jaws are ‘tuned’ to fit the channel aperture and shape thereby conferring a smooth and strong snap and lock fit.

In one embodiment, the connection assembly includes a lever assembly that communicates with a jaw assembly including the jaw members and wherein the lever assembly and jaw assembly communicate via a wedged rod that interacts with the jaws of the jaw assembly located between the jaw assembly pivot axis and the distil ends of the jaw members where:
(a) when the lever assembly is in an open position, the jaw members compress together so as to slot into a channel so that the base portion abuts the top of a channel containing member, and;
(b) when the lever assembly is in a closed position, the jaw members are forced to act against the channel thereby fixing the channel containing member to the connection assembly.

Preferably, the lever assembly includes an elongated lever (hereafter termed ‘handle’) connected via an over centre lever arrangement to a wedge shaped rod (hereafter termed ‘wedged rod’). In one embodiment, the over centre arrangement includes at least one U-shaped profile link and a pivot arrangement that translates rotational movement of a handle into lateral horizontal plane movement of a wedged rod. It should be appreciated that the over centre arrangement provides additional leverage to the user to lock the connection assembly in a closed position and creates an extra degree of strength and redundancy over other designs such as where a bolt may be used. For example, a bolt may loosen over time whereas the over centre arrangement of the connection assembly effectively designs out risk of loosening in a similar manner to that of a quick release lever fixing a bicycle wheel to a bike frame.

Preferably, the lever assembly and jaw assembly communicate via a wedged rod that passes through an aperture in the jaws of the jaw assembly located between the jaw assembly pivot axis and the distil ends of the jaw members. The wedged rod is preferably shaped to impose a lateral force on the jaw members so that, as the wedged rod is moved into the jaw member apertures, the articulated ends of the jaw members are forced apart. Conversely, as the wedged rod is withdrawn from the jaw member apertures, the jaw members relax and the distil ends of the articulated jaw members may move together.

In one embodiment, the jaw members of the jaw assembly are also lifted in a vertical plane when the lever assembly is closed or locked.

In one embodiment, the wedged rod may be shaped to impose a vertical upwards force on the jaw assembly thereby lifting the jaw members as well as forcing the members apart laterally. In this embodiment, the jaw assembly pivot rod may be retained within a widened aperture to allow for movement of the pivot rod in the vertical plane.

In one embodiment, the wedged rod may have an end projection located at the distil and non-handle end of the wedged rod. The end projection may be a boss or flange shape and is primarily used to seat a bias means such as a spring between the wedged rod and frame or support structure. The spring biases the wedged rod towards the handle when the handle is opened thereby allowing the jaws of the jaw assembly to relax and be compressed together. The end projection may also be used to seat the wedged rod within the support structure; to set a predetermined limit of wedge rod movement out of the jaw assembly; and may be used to provide a wider base for the wedge rod to abut the disc cam.

In a further embodiment, the connection assembly includes a base member through which the jaw members of the jaw assembly protrude to the opposing side of the base member.

In one embodiment, the base member may include a footpad, a base plate and a support frame for the lever and jaw assemblies.

The footpad may be shaped to have an elongated ellipse shape with projections to communicate with other items of the assembly including a base plate, a frame or support structure and a cover or enclosure. The footpad and base plate may include a centrally located aperture through which the jaw members protrude to the underside of the connection assembly. In one embodiment, the footpad may be manufactured from a flexible, pliant and/or elastomeric material. For example, the foot pad may be manufactured from a soft plastic or rubber.

The base plate communicates with and is received by the footpad, preferably with an interposing shape. In one embodiment, the footpad may be manufactured to receive and retain the base plate. The base plate may be manufactured from a semi-rigid to rigid material such as stainless steel, aluminium or other alloys, particularly those that maintain their integrity in open environments.

In preferred embodiments the lever and jaw assemblies are retained within a frame or internal structure. In one embodiment the frame is a moulded plastic structure that communicates with at least one or more of the pivot rods and orientates the lever and/or jaw assemblies in the connection assembly.

Preferably the connection assembly also includes a cover or enclosure. In one embodiment, the enclosure communicates with the base member. The handle when in a closed or locked position preferably lies approximately flush with the exterior of the enclosure and, when opened, projects forward from the enclosure. In a further embodiment, the enclosure has an elongated convex part ovoid shaped exterior. A concave section under the handle may also be added so that, when the handle is closed, a user can gain access to the underside of the handle for easy opening. While other shapes may be used, the exterior shape of the enclosure is ideally one that is aerodynamic to minimise drag and wind noise and ideally, is also aesthetically pleasing.

In one embodiment, the connection assembly may also include a rotating disc cam. The disc cam may be interposed between the wedged rod and base member and may protrude from the exterior of the connection assembly enclosure to allow adjustment without removing the enclosure. The disc cam may include at least one wedge section to translate rotation movement of the disc cam into vertical displacement of the wedge rod. As may be appreciated, the aim of the disc cam is to provide a coarse adjustment means to datum the lift of the jaws before locking the lever assembly. In one embodiment the disc cam includes two wedge sections that urge opposing ends of the wedge rod in a vertical direction (up or down) relative to the base member depending on the direction of rotation of the disc cam by the user. As may be appreciated from the above description, moving the wedge rod upwards relative to the base portion imposes a force on the jaw assembly pivot rod that causes the jaws to lift or rise up relative to the base member. Similarly, if the wedge rod is lowered for example, by rotating the disc cam in the opposite direction, the jaws lower relative to the base member. The disc cam allows for tolerance variation in channel design. The size of the channel may vary due to normal manufacturing variances and the disc cam allows the jaws to be easily pre-adjusted for a variety of sized channels prior to final locking via the lever assembly. In one embodiment the degree of adjustment may be less than 3 mm in vertical difference. In a further embodiment, the adjustment is less than approximately 1.5 mm. In a further embodiment, the disc cam includes a projection to limit the amount of rotation of the disc cam and thereby provide a minimum and maximum limit of adjustment in vertical height.

In one embodiment, the connection assembly includes a means to link the upper portion of the assembly to an accessory rack or accessory item. For the purposes of this specification, accessory racks include: a rack or racks on which item holders are mounted e.g. a cycle holder, a kayak holder, a fishing rod holder, a ladder holder and so on. The term accessory items include: a cycle holder, a kayak holder, a fishing rod holder, a ladder holder and so on. As should be appreciated from the above description, typically cross bars on a roof rack are linked with a forward facing rack on which are mounted various items however, the items may also be directly linked to the connection assembly without need to use a separate rack without departing from the scope of the invention. In addition, it should be appreciated that the connection assembly may be used in an opposite orientation with the accessory rack or accessory item fitting the jaws. In a further option, the connection assembly may have articulated jaw members protruding from both an upper and lower surface and racks or items attached via the jaws to both sides of the connection assembly.

In one embodiment, the linking mechanism may be at least one upstand that protrudes from the upper portion of the connection assembly. More specifically, two upstands may be used that protrude from the upper exterior of the connection assembly and which are linked internally to the connection assembly. The upstands may be received within a rack accessory bar and a bolt or bolts threaded through one or more interlinking apertures on the upstand or upstands to link the connection assembly to the rack accessory bar.

It should be appreciated that many other linking arrangements may also be possible without departing from the scope of the invention and the above embodiment is provided by way of example only.

It should be appreciated from the above description that there is provided a connection assembly to connect or link items on a vehicle roof rack. Due to the way the assembly fits together and locks, it should be appreciated that installation is very easy to achieve and comparatively quicker to achieve than the art which can require use of bolts, hard to reach levers and so on. In addition, the connection assembly is lightweight yet is strong and ideally has a comparatively aerodynamic external profile thereby reducing wind resistance when the vehicle is driven and therefore also reducing noise and fuel use. A further advantage is that the connection assembly may be fitted at any point along a channel in an extrusion whereas art methods that utilise bolts or specific slots only allow for one or a very limited range of positions on the channel.

### BRIEF DESCRIPTION OF THE DRAWINGS

Further aspects of the present invention will become apparent from the following description that is given by way of example only and with reference to the accompanying drawings in which:

FIG. 1 illustrates a perspective view of one embodiment of the connection assembly in an assembled form and not linked to other items;

FIG. 2 illustrates a perspective view of the connection assembly with the cover and support frame removed to expose the lever assembly, jaw assembly and other internal aspects of the connection assembly;

FIG. 3 illustrates a perspective view of the connection assembly with the cover and support frame removed as viewed from underneath exposing the articulated jaw members;

FIG. 4 illustrates a side elevation detail view of the lever and jaw assemblies;

FIG. 5 illustrates a front elevation detail view of the lever and jaw assemblies;

FIG. 6 illustrates a perspective view of the connection assembly with the support frame and upstands included;

FIG. 7 illustrates a perspective view of the connection assembly attached to an accessory rack and a roof rack crossbar;

FIG. 8 illustrates a side elevation view of the connection assembly connected to a cross section of the accessory roof rack;

FIG. 9 illustrates a perspective view of the connection assembly linked to a T-slot roof rack extrusion and an accessory rack; and,

FIG. 10 illustrates a perspective view of the connection assembly linked to a linking assembly, a roof rack crossbar and an accessory rack.

### BEST MODES FOR CARRYING OUT THE INVENTION

The invention is now described with reference to a detailed description of an embodiment of the connection assembly mechanism and a related method of use. The example described refers to a connection assembly whereby the jaws of the assembly communicate with roof rack cross bars and the upper surface of the connection assembly communicates with an accessory rack via a slot and bolt arrangement. This should not be seen as limiting as the jaws may be used instead to attach the accessory rack (or directly attach accessory items) and two sets of opposing jaws may also be used without departing from the scope of the invention.

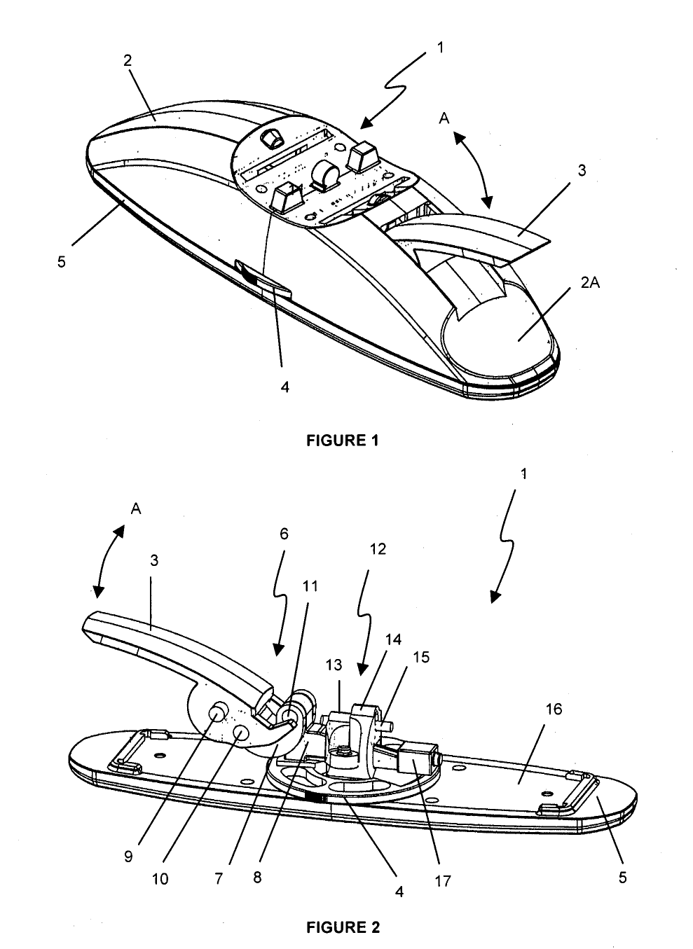

Referring to FIG. 1, a perspective view of the connection assembly, generally indicated by arrow 1 is illustrated. As shown, the assembly 1 includes a cover or enclosure 2 that has an elongated part ovoid shape designed to be aerodynamic so as to reduce wind resistance when fitted to a vehicle (not shown). The assembly 1 also includes a handle 3 that reversibly rotates along an arc generally indicated by arrow A. The cover 2 includes a recessed concave portion 2A under the handle 3 that allows for easy release and replacement of the handle 3 by a user. The cover 2 is also shaped so as to minimise any protrusion of the handle 3 above the cover 2 profile when in the closed position. The connection assembly 1 also includes a disc shaped cam 4 that protrudes from the cover 2 as shown in FIG. 1. The disc shaped cam 4 may be rotated by the user and acts as a datum to coarsely adjust the spread of the jaws (see later description). The connection assembly also includes a foot pad 5.

Referring to FIG. 2, the connection assembly 1 is illustrated with the cover 2 and a support structure (see later) removed to expose the lever assembly 6, jaw assembly 12 and other internal features of the connection assembly 1. The lever assembly 6 includes the handle 3 that communicates with a U-shaped link 7 and in turn with a wedge rod 8. The wedge rod 8 is shaped to have a flat base or underside and a cross section that widens and increases in height from a maximal cross section at the handle 3 end of the wedge rod 8 and a minimal cross section at the opposing end of the wedge rod 8. The handle 3 when rotated about arc A, rotates about an axis defined by a handle pivot rod 9. Handle pivot rod 9 is held in place by the support structure (see later). Rotation of the handle 3 urges motion of the U-shaped link 7 around two axes defined by the cam pivot rod 10 and the wedge rod pivot rod 11 conferring an over centre lever effect. Rotational movement of the handle 3 via the U-shaped link 7 in turn urges motion of the wedge rod 8 in a horizontal plane. Movement of the wedge rod 8 in turn causes the jaw assembly 12 to move. The jaw assembly 12 includes two opposable articulated jaw structures 13 and 14. These structures 13,14 pivot open and shut about an axis defined by the jaw assembly pivot rod 15. The jaws 13,14 of the jaw assembly 12 include an aperture through which the wedge rod 8 is received. Movement of the wedge rod 8 in a horizontal plane impinges on the jaw assembly 12 causing the jaws 13,14 to spread and lock open when the wedge rod 8 is forced forwards into the jaw assembly 12 aperture (i.e. the handle 3 flush with the enclosure 2 and in a closed position). Conversely, the jaws 13,14 are relaxed and are free to compress together when the wedge rod 8 moves backwards out of the jaw assembly 12 (i.e. when the handle 3 is lifted and moved to an open position). In the drawings shown, the wedged rod 8 also lifts the jaw assembly 12 in a vertical plane by use of an inclined plane on the top of the wedged rod 8 surface.

Also as shown in FIG. 2, the disc cam 4 includes two wedge sections located to abut the wedge rod 8. As noted above, the disc cam 4 may be used as a datum or coarse adjustment mechanism to pre-set the degree of jaw 13,14 lift. In the embodiment shown in FIG. 2, if the disc cam 4 is rotated in a clockwise direction when viewed from above the connection assembly 1, the rotational movement of the disc cam is translated into a vertical plane and the height of the wedge rod 8 is increased by the disc cam 4 wedges. This height adjustment causes the jaws 13,14 to lift or lower thereby pre-setting the jaw 13,14 height (i.e. amount of protrusion from the underside of the base member) for varying channel aperture dimensions. For example, the channel may be a T-slot in a roof rack extrusion to which the connection assembly 1 may be fitted. The disc cam 4 allows the jaw assembly 12 height to be adjusted to suit the thickness of T-slot flanges in a T-slot channel and thereby account for manufacturing variations.

In the embodiment shown in FIG. 2, the wedge rod 8 also includes a wedge rod end projection 17. The end projection 17 primarily acts as a boss to seat the spring or biasing means (not shown) that links the wedge rod to the internal frame structure. The end projection 17 may also be used to seat or locate the wedge rod 8 within the support structure (see later); sets a predetermined limit of wedge rod 8 movement out of the jaw assembly 12; and may be used to provide a wider base for the wedge rod 8 to abut the disc cam 4.

Finally, FIG. 2 also further illustrates the footpad 5 and a base plate 16 that form the base member of the connection assembly 1. The footpad 5 may be shaped to have an elongated part ovoid shape with various vertical projections to communicate with a base plate 16 and/or other items of the assembly 1 including the frame support structure and a cover or enclosure 2.

In the embodiment illustrated, the footpad 5 includes a centrally located aperture through which the jaws 13,14 protrude to the underside of the connection assembly 1. Further, in the embodiment illustrated, the footpad 5 is manufactured from a flexible, pliant and/or elastomeric material for example a soft plastic or rubber.

The base plate 16 communicates with and is received by the footpad 5 with an interposing shape. In the embodiment illustrated, the footpad 5 is manufactured to receive and retain the base plate 16. The base plate 16 is made of a semi-rigid to rigid material such as stainless steel, aluminium or other alloys, particularly those that maintain their integrity in open environments.

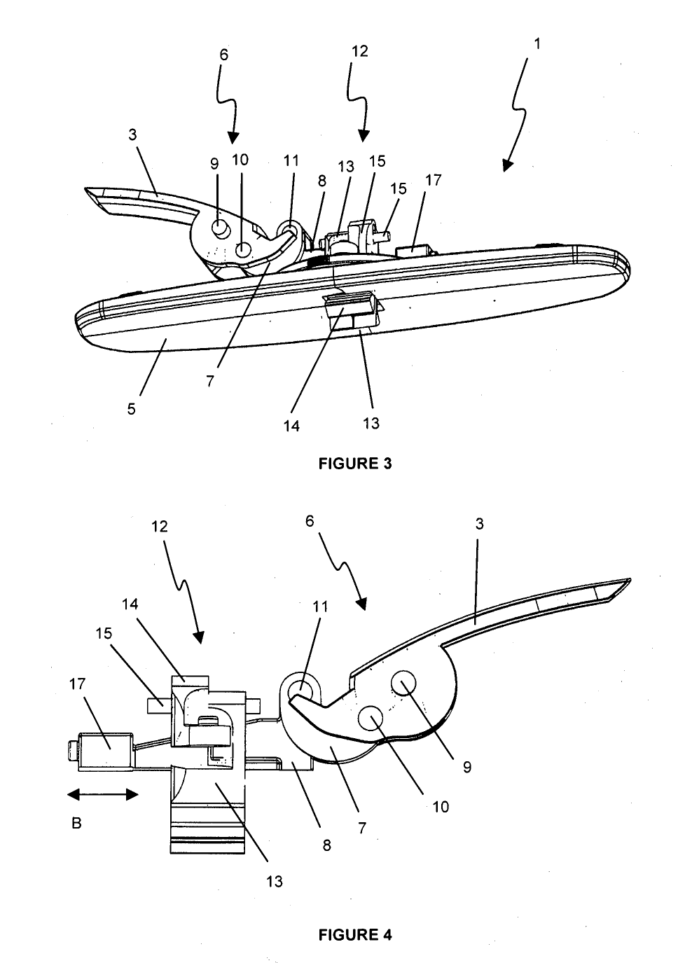

Referring to FIG. 3, the connection assembly 1 is shown from the underside. The jaws 13,14 of the jaw assembly 12 are shown in more detail and can be seen protruding from the underside of the footpad 5.

Referring to FIG. 4, a detailed side view is shown of the lever assembly 6 and the jaw assembly 12. With the foot pad 5 and base plate 16 removed, the jaws 13,14 may be viewed in more detail. As shown in FIG. 4, the jaws 13,14 are interposed and abut each other. They pivot about the jaw assembly pivot rod 15 as the wedge rod 8 is moved in a horizontal direction generally indicated by arrow B.

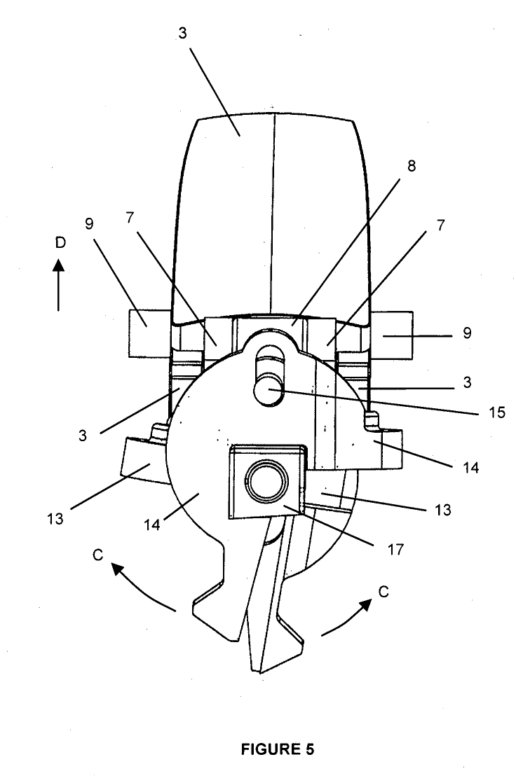

Referring to FIG. 5, more detail of the lever 6 and jaw 12 assembly are illustrated. As can be seen, the jaws 13,14 are able to pivot about the rod 15 in both a rotational lateral direction indicated by arrows C and also in a vertical plane as indicated by arrow D. The jaws 13,14 include a widened aperture in the vertical plane to allow for a degree of pre-defined movement of the jaw assembly pivot rod 15 in the vertical direction. When the handle 3 is closed, the jaws 13,14 are both spread apart and lifted up in a vertical direction by the force of the wedge rod 8 as it is urged forwards through the jaw assembly 12 aperture. Conversely, when the handle 3 is opened, the wedge rod 8 moves backwards through the jaw assembly 12 aperture and the jaws 13,14 relax and both close and drop. It should be appreciated that vertical movement need not be essential and can be adjusted by varying the profile of the wedged rod 8 and jaw assembly pivot rod 15 aperture.

The jaws 13,14 have an angled profile adapted to be received into a channel (not shown), particularly a T-slot extrusion channel although moulds and die casts containing channels may also be used), preferably, in a longitudinal alignment. The angled profiles of the jaws 13,14 interpose with the T-slot flanges and, when clamped, the jaws are forced apart and up thereby clamping the T-slot flanges between the jaws 13,14 and the footpad 5 of the connection assembly 1. The inventors have found that this angle is critical in order to achieve that desired snap fit and lock action. If the angle is too steep relative to the jaw assembly pivot axis, the jaws will fit too easily into the channel and may not be sufficiently held. In contrast, if the angle is too shallow relative to the jaw assembly pivot axis, the jaws are difficult if not impossible to fit through the channel. The ideal angle range identified by the inventors is from 30 to 60 degrees relative to a perpendicular axis. Notwithstanding this range of angle, the angles of the jaws are ‘tuned’ to fit the channel aperture and shape thereby conferring a smooth and strong snap and lock fit.

In use, when the handle 3 is lifted to an open position, the jaws 13,14 are aligned in an approximately longitudinal position relative to the channel of a roof rack and then the protruding jaws 13,14 of the connection assembly 1 are snapped or forced into the channel. The handle 3 is then closed and the connection assembly 1 and any accessory attached to the connection assembly 1 are secured.

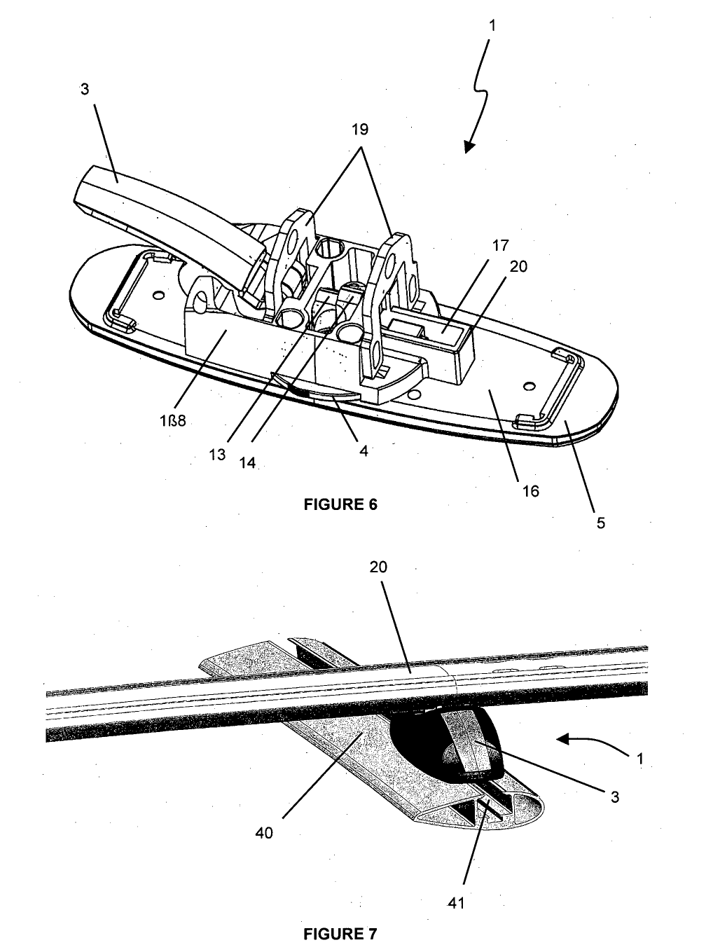

Referring to FIG. 6, the assembly 1 includes a frame or internal structure 18 to retain the lever 6 and jaw 12 assemblies in position. The frame 18 in the embodiment described may be plastic although other materials may be used without departing form the scope of protection.

As should be appreciated, the connection assembly 1 may be attached to a roof rack accessory in a variety of ways using bolts, further snap locks and so on. FIG. 6 illustrates one arrangement utilised by the inventors where two upstands 19 are located inside the support frame 18 and which protrude from the cover 2 of the connection assembly 1.

As shown in FIG. 7, the connection assembly 1 may be attached to a roof rack accessory 20, in this case an accessory rack 20 and a roof rack crossbar 40.

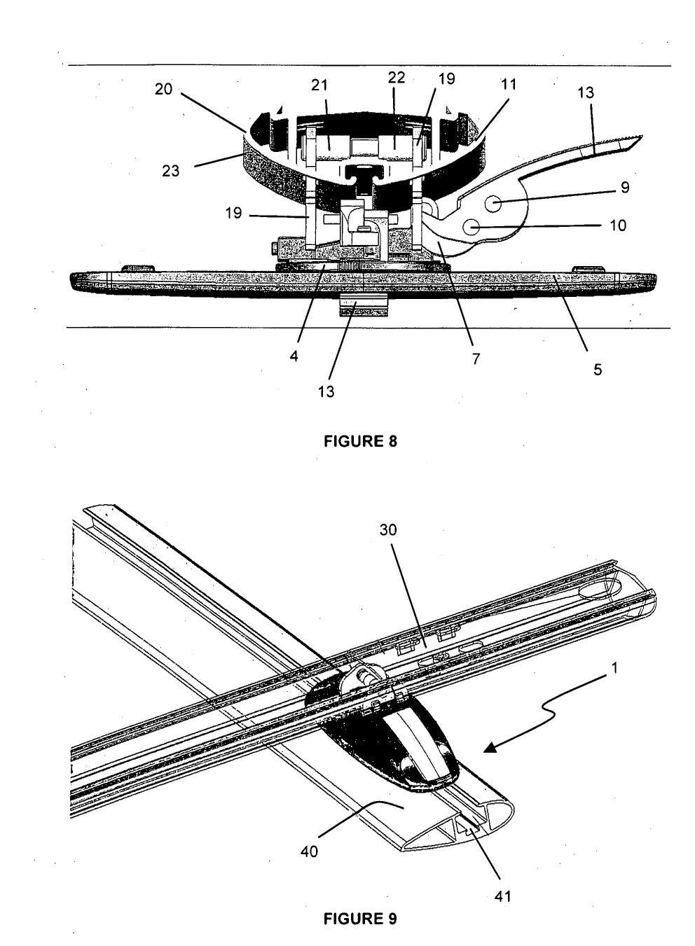

FIG. 8 further illustrates the upstands 19 used to attach the connection assembly 1 to the accessory rack 20. As shown in FIG. 8, the upstands 19 are retained in place via a male and female thread bolt 21, 22. The bolt 21,22 retains the connection assembly 1 in place by extending through the upstand 19 apertures and accessory rack 20 as the bolt 21,22 is turned. In one embodiment, the bolt 21,22 works in two stages with each side 21 or 22 extending through the apertures in turn as the user tightens the bolt 21, 22.

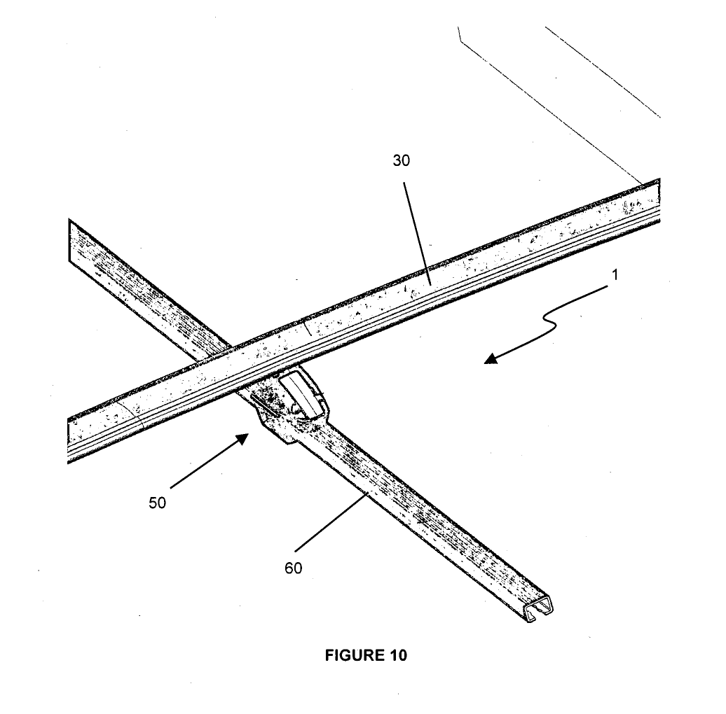

Finally, as shown in FIG. 9 and FIG. 10, the connection assembly 1 may be used to link a roof rack accessory bar 30 or item to a variety of channel 41 containing linkages. FIG. 9 illustrates the connection assembly 1 linked to an extruded crossbar 40 that has a T-slot shaped channel 41. FIG. 9 shows the connection assembly 1 slotted into the channel (not shown) of a linking assembly 50 that joins the connection assembly 1 to a square shaped roof rack crossbar 60.

It should be appreciated from the above description that there is provided a connection assembly 1 that may be used to quickly and easily fit an accessory to a roof rack. No bolts or difficult to reach levers are used and installation is a very fast and simple snap and lock process. The action of the lever 6 and jaw 12 assemblies is very simple and once locked, is very strong and secure.

Aspects of the present invention have been described by way of example only and it should be appreciated that modifications and additions may be made thereto without departing from the scope of the claims herein.

1. A connection assembly to link a vehicle roof rack to a roof rack accessory including:
(a) a first connection mechanism including at least two opposing jaw members that are shaped to fit and be received by a channel in a roof rack or roof rack accessory and wherein, the jaw members may be compressed together so as to slot into a channel and, once in the channel, retain the connection assembly within the channel; and,
(b) a second connection mechanism linking the first connection assembly to a roof rack or roof rack accessory.

2. The connection assembly of claim 1 wherein the jaw members are biased apart.

3. (canceled)

4. The connection assembly of claim 1 wherein the jaw members rotate about a common axis at the jaw apex to open and close the members.

5. The connection assembly of claim 4 wherein rotation occurs about a jaw assembly pivot rod that links the two jaw members together at the approximate apex of the jaw members.

6. The connection assembly of claim 1 wherein the jaw members are shaped with an angled profile.

7. The connection assembly of claim 6 wherein the angle at which the jaws strike the channel is from 30 to 40 degrees relative to a perpendicular axis.

8. The connection assembly of claim 1 wherein the channel is a T-slot channel.

9. The connection assembly of claim 8 wherein the angled profile is such that, when the jaw members are forced apart in a lateral plane, the profile bites on the flanges of the T-slot channel and compresses the flanges between the jaws and the connection assembly.

10. The connection assembly of claim 1 wherein the channel containing member is selected from: an extrusion, a moulding, a die cast, and combinations thereof.

11. The connection assembly of claim 1 wherein the connection assembly includes a lever assembly that communicates with a jaw assembly including the jaw members and wherein the lever assembly and jaw assembly communicate via a wedged rod that interacts with the jaws of the jaw assembly located between the jaw assembly pivot axis and the distil ends of the jaw members where:
(a) when the lever assembly is in an open position, the jaw members compress together so as to slot into a channel so that the base portion abuts the top of a channel containing member, and;
(b) when the lever assembly is in a closed position, the jaw members are forced to act against the channel thereby fixing the channel containing member to the connection assembly.

12. The connection assembly of claim 11 wherein the lever assembly includes a handle connected via an over centre lever arrangement to the wedged rod.

13. The connection assembly of claim 12 wherein the over centre arrangement includes at least one U-shaped profile link that is linked to the handle and wedged rod and a pivot arrangement that translates rotational movement of a handle into lateral horizontal plane movement of the wedged rod.

14. The connection assembly of claim 11 wherein the wedged rod is shaped to impose a lateral force on the jaw members so that, as the wedged rod is moved into the jaw member apertures, the articulated ends of the jaw members are forced apart.

15. The connection assembly of claim 11 wherein, as the wedged rod is withdrawn from the jaw member apertures, the ends of the jaw members relax and the distil ends of the jaw members may move together.

16. The connection assembly of claim 11 wherein the jaw members are lifted in a vertical plane when the lever assembly is in a closed position.

17. The connection assembly of claim 11 wherein the wedged rod is shaped to impose a vertical upwards force on the jaw assembly thereby lifting the jaw members as well as forcing the members apart laterally.

18. The connection assembly of claim 11 wherein a jaw assembly pivot rod is retained within a widened aperture to allow for movement of the pivot rod in a vertical plane.

19-30. (canceled)

31. A vehicle roof rack assembly comprising
a crossbar configured for mounting across a vehicle roof, the crossbar having a channel running longitudinally across an upper side of the crossbar,
a connection device having a top side and a bottom side, the connection device including a cleat located on the bottom side and being dimensioned to fit in the channel of the crossbar, the cleat being moveable between a disengaged position and an engaged position in which the cleat grips an inner surface of the channel preventing the cleat from exiting the channel, and a lever having a released position and a secured position, wherein movement of the lever from the released position to the secured position causes the cleat to move from the disengaged position to the engaged position, the connection device having a fastening mechanism on the top side configured for attaching a roof rack or roof rack assembly to the connection mechanism.

32. The vehicle roof rack of claim 31, further comprising
a second cleat located on the bottom side of the connection device and being dimensioned to fit in the channel of the crossbar, the cleat being moveable between a disengaged position and an engaged position in which the cleat grips an inner surface of the channel preventing the cleat from exiting the channel.

33. The vehicle roof rack of claim 31, wherein the lever pivots around an axis that is perpendicular to a longitudinal axis of the crossbar.

34. The vehicle roof rack of claim 32, wherein each cleat is driven from the disengaged position to the engaged position when the lever is moved from released position to the secured position.

35. A vehicle roof rack assembly comprising
a crossbar configured for mounting across a vehicle roof, the crossbar having a channel running longitudinally across an upper side of the crossbar,
a connection device having a top side and a bottom side, the connection device including a cleat located on the bottom side and being dimensioned to fit in the channel of the crossbar, the cleat being moveable between a disengaged position and an engaged position in which the cleat grips an inner surface of the channel preventing the cleat from exiting the channel, and a lever being pivotal around an axis perpendicular to a longitudinal direction of the channel and having a released position and a secured position, wherein movement of the lever from the released position to the secured position causes the cleat to move from the disengaged position to the engaged position, the connection device having a fastening mechanism on the top side configured for attaching a roof rack or roof rack assembly to the connection mechanism.

36. The vehicle roof rack of claim 35, further comprising
a second cleat located on the bottom side of the connection device and being dimensioned to fit in the channel of the crossbar, the cleat being moveable between a disengaged position and an engaged position in which the cleat grips an inner surface of the channel preventing the cleat from exiting the channel.

37. The vehicle roof rack of claim 36, wherein each cleat is driven from the disengaged position to the engaged position when the lever is moved from released position to the secured position.
